(19) United States
(12) Patent Application Publication
(10) Pub. No.: US 2026/0224976 A1
(43) Pub. Date: Aug. 6, 2026

(54) Puzzle tool integrated with multifunctional feature

(71) Applicant: Shenzhen Nailong Technology Co., LTD, Shenzhen (CN)

(72) Inventors: Shuo Cao, Shenzhen (CN); Yongshan Chen, Shenzhen (CN)

(21) Appl. No.: 19/629,373

(22) Filed: Mar. 26, 2026

(30) Foreign Application Priority Data
Mar. 27, 2025 (CN) 202510375888.5

(51) Int. Cl. A63F 9/10

(52) U.S. Cl. CPC A63F 9/1044

(57) ABSTRACT

A puzzle tool integrated with a multifunctional feature is provided, including a puzzle board body, a bracket assembly, and a rim. The puzzle board body can be folded in half along an axis. An insertion slot corresponding to a folding axis of the puzzle board body is provided in a top end of the puzzle board body. A working layer for assisting in doing a puzzle is arranged on a surface. The bracket assembly can be inserted into the insertion slot at the top end of the puzzle board body and detachably connected to the puzzle board body. The bracket assembly includes a first movable bracket and a second movable bracket that can rotate independently or relative to each. The first movable bracket is configured to support the puzzle board body to cause the puzzle board body to be in an inclined supporting state relative to a placement plane.

### TECHNICAL FIELD

The present disclosure relates to the technical field of puzzle tools, and in particular, to a puzzle tool integrated with a multifunctional feature.

### BACKGROUND

In recent years, puzzle activities have become increasingly popular worldwide. They not only become a popular choice for family gatherings and parent-child interactions, but also frequently appear in various social occasions. Assembling puzzles not only cultivates participants' patience, concentration, and logical thinking, but also brings visual enjoyment in a puzzle assembling process and a sense of accomplishment upon completion. As the community of puzzle enthusiasts continues to grow, the market demand for puzzle-related products has also become increasingly diverse and elaborated.

In the field of traditional puzzle tools, puzzle boards have always held a central position. Early puzzle boards are relatively basically designed, and have a main function of providing a flat assembling plane for puzzle pieces. However, in the context of the accelerated pace of modern life, people's expectations for usage scenarios and functions of puzzle boards have undergone significant changes.

In terms of convenience, modern consumers often hope to enjoy puzzle fun in various environments, such as traveling, camping outdoors, or switching freely between different home spaces. However, a traditional flat puzzle board lacks a portable design, has a relatively large volume and a fixed shape, so that it easily takes up a large space when carried and brings inconvenience to users.

In terms of functionality, a traditional puzzle tool has a single function, so that it cannot provide users with more conveniences besides completing the basic operation of doing a puzzle.

With the improvement of the quality of people’s life and the increasing demand for the puzzle experience, higher requirements have been put forward for the convenience and functionality of the puzzle board. In this context, developing a puzzle tool integrated with a multifunctional feature is of important practical significance.

### SUMMARY

To overcome the drawbacks described above, the present disclosure aims to provide a technical solution that can solve the above problems.

A puzzle tool integrated with a multifunctional feature includes a puzzle board body, a bracket assembly, and a rim.

The puzzle board body is folded in half along an axis. An insertion slot corresponding to a folding axis of the puzzle board body is provided in a top end of the puzzle board body. A working layer for assisting in doing a puzzle is arranged on a surface.

The bracket assembly is inserted into the insertion slot at the top end of the puzzle board body and is detachably connected to the puzzle board body. The bracket assembly includes a first movable bracket and a second movable bracket that can rotate independently or relative to each other. The first movable bracket is configured to support the puzzle board body to cause the puzzle board body to be in an inclined supporting state relative to a placement plane. The second movable bracket is configured to form an object placement position or cooperate with the puzzle board body to form an object placement position.

The rim is detachably connected to the puzzle board body. The rim is correspondingly divided into a first half rim and a second half rim along a central axis of the puzzle board body, to compress the working layer to achieve fixation of the working layer.

In a further solution of the present disclosure, the bracket assembly further includes a connection member connected to the puzzle board body. The first movable bracket and the second movable bracket are respectively movably connected to the connection member and are able to rotate around connection points.

The connection member is of a plugboard structure. Connection between the bracket assembly and the puzzle board body is achieved by inserting the connection member into the insertion slot.

In a further solution of the present disclosure, a connection shaft is arranged on the connection member.

The first movable bracket is sleeved on the connection shaft and is rotatably connected to the connection shaft.

The second movable bracket is sleeved on the connection shaft, is located between the first movable bracket and the connection member, and is rotatably connected to the connection shaft.

The first movable bracket and the second movable bracket are able to rotate relative to the connection member around the connection shaft. The first movable bracket and the second movable bracket are also able to rotate relative to each other around the connection shaft.

In a further solution of the present disclosure, after the connection member is inserted into the insertion slot of the puzzle board body, the first movable bracket and the second movable bracket are fixed to the top end of the puzzle board body. The first movable bracket is able to support the puzzle board body after rotation. After rotation, the second movable bracket cooperates with the top end of the puzzle board body to form the object placement position.

In a further solution of the present disclosure, the insertion slot corresponds to a folding position of the puzzle board body, so that after the connection member is connected to the puzzle board body, when the puzzle board body is in an unfolded state, the puzzle board body is constrained to suppress a degree of freedom of rotation of the puzzle board body around the folding axis, to maintain stability of unfolding of the puzzle board body.

In a further solution of the present disclosure, a magnetic attraction connection assembly is disposed between the puzzle board body and the rim. Stable magnetic attraction mating between the rim and the puzzle board body is achieved through the magnetic attraction connection assembly.

In a further solution of the present disclosure, a convex platform structure is arranged on a surface of the puzzle board body. An upper surface of the convex platform structure forms a mounting plane of the working layer, and a stepped slot matching with the rim is provided around a periphery of the convex platform structure. The rim is embedded into the stepped slot.

In a further solution of the present disclosure, the rim has a compression portion and a connection portion that are of an integrated structure.

The compression portion corresponds to the mounting plane of the convex platform structure on the surface of the puzzle board body and is configured to compress the working layer arranged on the mounting plane.

The connection portion corresponds to a stepped slot around a peripheral side of the convex platform structure and is configured to be embedded into the stepped slot, to achieve stable connection between the rim and the puzzle board body.

In a further solution of the present disclosure, the rim encloses a slot position corresponding to the working layer, and a cover plate that is detachably connected to the puzzle board body is disposed on the slot position.

When no puzzle assembling operation is performed, the cover plate tightly presses the working layer in the slot position to fix a puzzle on the working layer.

In a further solution of the present disclosure, the puzzle tool integrated with the multifunctional feature further includes a drawer rotatably connected to the puzzle board body. The drawer is able to extend out from or be stored into the puzzle board body during rotation.

In a further solution of the present disclosure, the puzzle board body is provided with a built-in slot configured to store the drawer. The drawer is rotatably connected to the puzzle board body through a rotating shaft, so as to be able to extend out from the built-in slot around the rotating shaft or be stored into the built-in slot.

In a further solution of the present disclosure, the drawer is of a semicircular structure capable of rotating around the rotating shaft serving as a center.

The built-in slot is in a semicircular shape matching with the drawer.

In a further solution of the present disclosure, an arc-shaped track is arranged on an inner wall of the built-in slot. An outer contour of the drawer abuts against the arc-shaped track, so that the drawer is able to steadily slide along the arc-shaped track when rotating around the rotating shaft.

In a further solution of the present disclosure, a plurality of partition structures are disposed within the drawer to partition an interior of the drawer into a plurality of independent storage regions through the plurality of partition structures.

In a further solution of the present disclosure, the partition structures are placement trays. Shapes of the placement trays match with an inner contour of the drawer. The placement trays are able to be taken out from the drawer.

Compared with the prior art, the present disclosure has the beneficial effects below:

1) Through the bracket assembly, the first movable bracket rotates to change an inclination angle of the puzzle board body, thereby enhancing light reflection and mitigating neck fatigue. The second movable bracket forms the object placement position (such as a mobile phone support) to enhancing convenience of use. Furthermore, the entire bracket assembly is stably connected, thus facilitating mounting, removal, and storage.

2) By virtue of the magnetic attraction rim, quick connection is achieved, and the felt working layer increases a frictional force to ensure stable assembling. The foldable design and the connection mechanism maintain good functionality during state switching of the product. Meanwhile, the convex platform and the rim work synergistically to compress the working layer. In addition, the magnetic attraction cover plate protects an assembled puzzle when a user does not do a puzzle.

3) The drawer is rotated to be flexibly stored through rotation and connection. The semicircular design uses the space efficiently, so that the operation is stable, and pieces inside are classified and managed through the partition structures. The removable placement trays enhance the flexibility and the convenience of cleaning. Meanwhile, it is more convenient for operation due to the magnetic attraction at an opening of the slot and a handle.

4) Overall, this puzzle tool comprehensively enhances the convenience and the functionality, and meets the modern diverse needs.

The additional aspects and advantages of the present disclosure will be set forth in part in the description below, parts of which will become apparent from the description below, or will be understood by the practice of the present disclosure.

### BRIEF DESCRIPTION OF THE DRAWINGS

To describe the technical solutions in the embodiments of the present disclosure or in the related art more clearly, the following briefly introduces the accompanying drawings for describing the embodiments or the related art. Apparently, the accompanying drawings in the following description show merely some embodiments of the present disclosure, and a person of ordinary skill in the art may still derive other drawings from the accompanying drawings without creative efforts.

FIG. 1 is a schematic diagram of a structure of a bracket assembly in a stored state on a puzzle board body in Embodiment 1;

FIG. 2 is a schematic diagram of a structure of a view of a bracket assembly in an unfolded state on a puzzle board body in Embodiment 1;

FIG. 3 is a schematic diagram of a structure of another view of a bracket assembly in an unfolded state on a puzzle board body in Embodiment 1;

FIG. 4 is a schematic diagram of a structure of a puzzle board body in Embodiment 1;

FIG. 5 is a schematic diagram of a structure of a bracket assembly in Embodiment 1;

FIG. 6 is a schematic diagram of a structure in which a puzzle board body is folded and is separated from a bracket assembly in Embodiment 1;

FIG. 7 is a schematic diagram of a structure of an implementation in Embodiment 1;

FIG. 8 is a schematic diagram of a structure in Embodiment 2;

FIG. 9 is a schematic diagram of an exploded structure of Embodiment 2;

FIG. 10 is a schematic diagram of an enlarged structure of part A in FIG. 9;

FIG. 11 is a schematic diagram of a structure of a folded state of Embodiment 2;

FIG. 12 is a schematic diagram of a structure of a cover plate being added in Embodiment 2;

FIG. 13 is a schematic diagram of a structure of a drawer being in a stored state in Embodiment 3;

FIG. 14 is a schematic diagram of a structure of a view of a drawer being in an extended state in Embodiment 3;

FIG. 15 is a schematic diagram of a structure of another view of a drawer being in an extended state in Embodiment 3;

FIG. 16 is a schematic diagram of a cross-sectional structure of a view of a drawer being in an extended state in Embodiment 3;

FIG. 17 is a schematic diagram of a cross-sectional structure of another view of a drawer being in an extended state in Embodiment 3;

FIG. 18 is a schematic diagram of a structure of a view according to the present disclosure; and

FIG. 19 is a schematic diagram of a structure of another view according to the present disclosure.

Reference numerals and names in the accompanying drawings are as follows:

10: puzzle board body; 101: built-in slot; 102: rotating shaft; 103: arc-shaped track; 104: shaft hole; 105: hinge structure;

20: drawer; 201: central hole; 202: partition structure; 203: storage region; 204: handle;

30: rim; 301: first half rim; 302: second half rim; 303: compression portion; 304: connection portion;

40: working layer;

50: convex platform structure; 501: stepped slot; 502: slot position;

60: cover plate;

70: bracket assembly; 71: first movable bracket; 72: second movable bracket; 73: connection member; 74: connection shaft;

80: object placement position; 81: insertion slot; 82: storage slot; 83: first connection position; and 84: second connection position.

### DETAILED DESCRIPTION OF THE EMBODIMENTS

The following clearly and completely describes the technical solutions in the embodiments of the present disclosure with reference to the accompanying drawings in the embodiments of the present disclosure. Apparently, the described embodiments are some of the embodiments of the present disclosure rather than all the embodiments. All other embodiments obtained by a person of ordinary skill in the art based on the disclosed embodiments without creative efforts shall fall within the protection scope of the present disclosure.

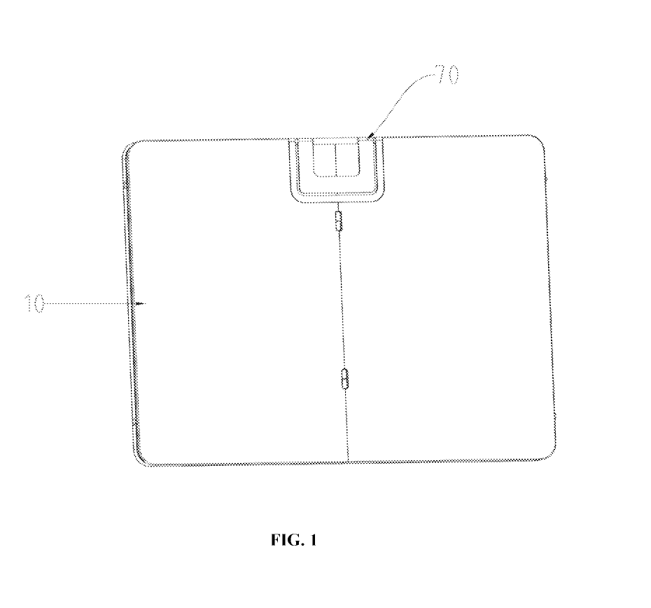

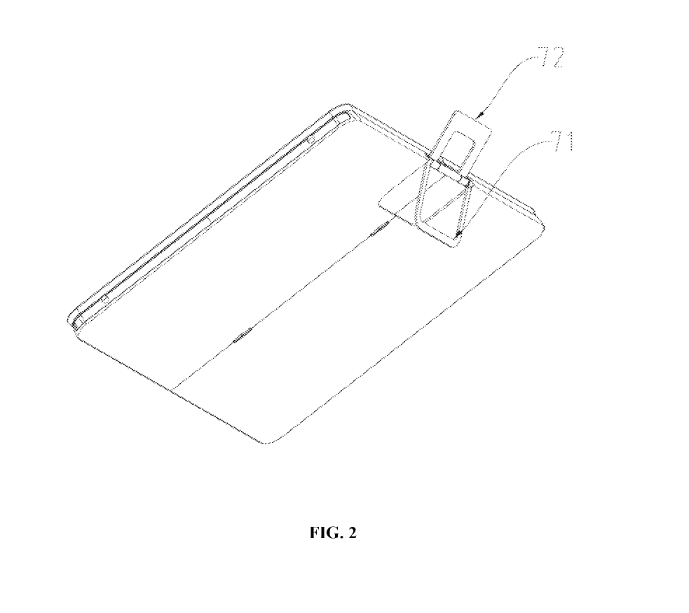

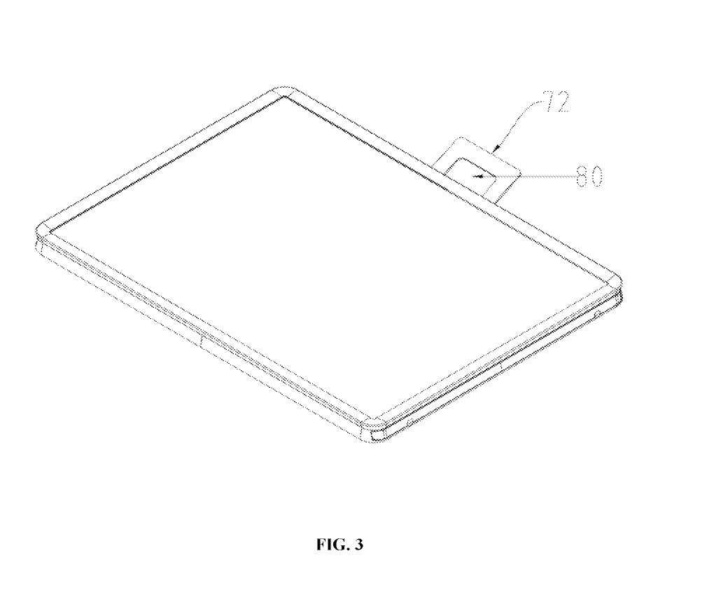

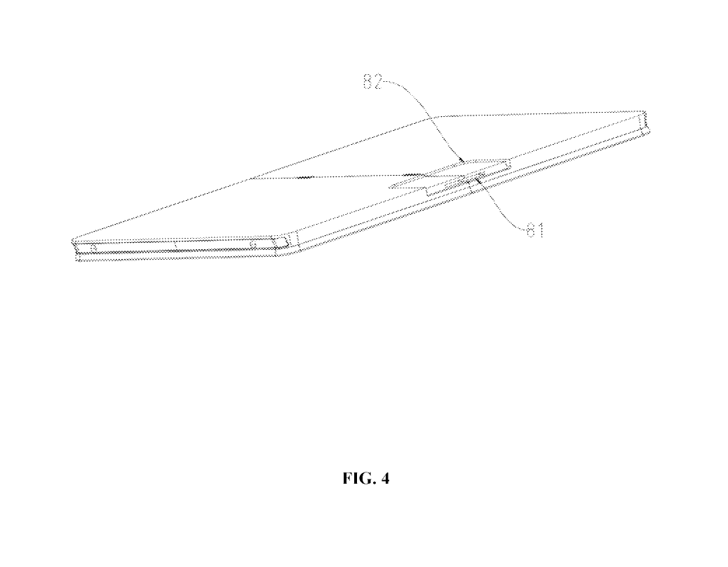

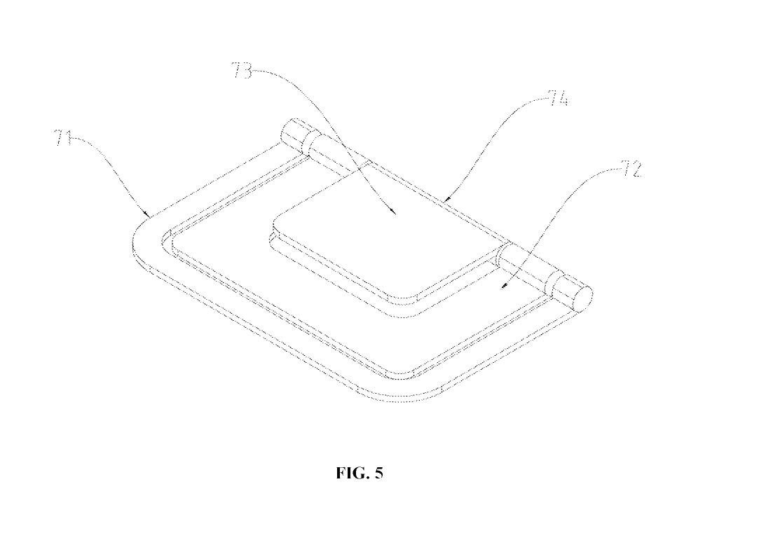

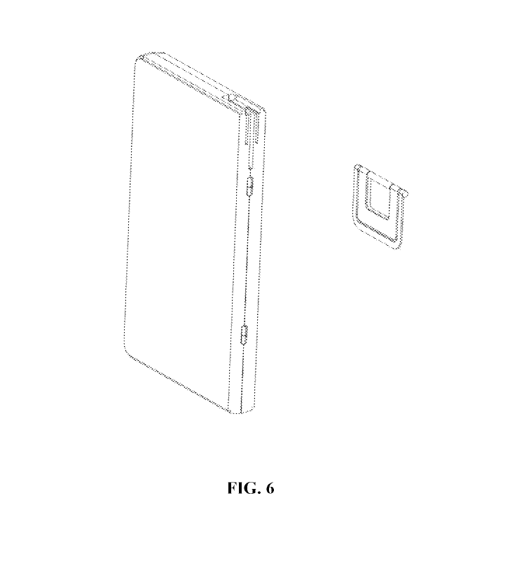

Referring to FIGS. 1 to 6, in Embodiment 1, a puzzle board with a multifunctional bracket includes a puzzle board body 10. The puzzle board body 10 is provided with a rotatable bracket assembly 70. The bracket assembly 70 includes a first movable bracket 71 and a second movable bracket 72 that can rotate independently or relative to each other.

The first movable bracket 71 is configured to support the puzzle board body 10 to cause the puzzle board body 10 to be in an inclined supporting state relative to a placement plane. The second movable bracket 72 is configured to form an object placement position 80 or cooperate with the puzzle board body 10 to form an object placement position 80.

During use of a traditional puzzle product, a user generally places the puzzle board body 10 on a horizontal desktop. The user has to lower the head for a long time. This easily leads to neck fatigue. In addition, in a horizontal state, light reflection can interfere with the observation of puzzle details.

To address this issue, the puzzle board with the multifunctional bracket is designed with the rotatable first movable bracket 71. The first movable bracket 71 can be connected to the puzzle board body 10 in a common shaft connection manner. A shaft acts as a fulcrum. Based on the lever principle, when the first movable bracket 71 rotates, one end of the first movable bracket 71 rotates around the fulcrum, while the other end is lifted upwards, to apply an upward supporting force to the puzzle board body 10, thereby changing an angle between the puzzle board body 10 and the placement plane. In one possible implementation, a plurality of preset snap-in slots can be formed in the first movable bracket 71 to cooperate with corresponding snap-in blocks on the puzzle board body 10, to achieve fixation at different inclination angles. Alternatively, a rotating shaft with a damping characteristic is used. The user fixes the puzzle board body 10 at a desired inclination angle by manual adjustment due to the damping characteristic of the rotating shaft. By adjusting a rotation angle of the first movable bracket 71, the puzzle board body 10 can achieve different degrees of inclination to meet a diversification need of the user for a viewing angle. This effectively enhances light reflection and reduces visual interference.

Considering that people often need to refer to external information, such as images and video tutorials in mobile phones or tablets, in a puzzle assembling process, existing puzzle products lack corresponding convenient placement functions.

To address this issue, the puzzle board with the multifunctional bracket is provided with the second movable bracket 72 that can rotate independently or relatively. The second movable bracket 72 and the puzzle board body 10 can be flexibly connected in a common shaft connection manner. When a reference device needs to be placed, the second movable bracket 72 rotates. In a feasible design, a clamping slot made of an elastic rubber material is arranged at an end portion of the second movable bracket 72. If an edge of the puzzle board body 10 matches with the clamping slot, the clamping slot can clamp the edge of the puzzle board body 10. If a corresponding portion of the puzzle board body 10 is made of a metal material, a magnetic attraction patch can be used to be nested with the corresponding portion of the puzzle board body 10 due to a magnetic attraction effect to form an object placement position 80. This manner for combining rotatable components at different positions to construct a new functional structure provides the user with a region specially for placing a device.

In summary, the first movable bracket 71 causes the puzzle board body 10 to be in the inclined supporting state, so that the user does not need to lower the head continuously, and the pressure on the neck muscles is reduced. It alleviates the neck fatigue to an extent. Meanwhile, the inclined puzzle board body 10 changes a light reflection path, so that light is not intensively reflected into the eyes of the user. This mitigates the impact of glare on the observation of puzzle details, and the user can more clearly distinguish patterns, colors, and assembling slits of a puzzle on the puzzle board body 10, thereby enhancing the puzzle assembling efficiency.

The object placement position 80 formed by or cooperatively formed by the second movable bracket 72 provides a stable placement space for a device such as a mobile phone and a tablet. Compared with placing the device casually beside the puzzle board body 10, placing the device at a designated placement position reduces the possibility of damage to the device because of sliding due to collision. In addition, by intensively placing the device at a placement position near the puzzle board body 10, the space of the desktop is saved, and the user can conveniently and quickly view information in the puzzle assembling process, so that the puzzle experience is enhanced.

In Embodiment 1 of the present disclosure, the bracket assembly 70 further includes a connection member 73 connected to the puzzle board body 10. The first movable bracket 71 and the second movable bracket 72 are respectively movably connected to the connection member 73 and can rotate around connection points. The connection member 73 is provided with a connection shaft 74.

The first movable bracket 71 is sleeved on the connection shaft 74 and is rotatably connected to the connection shaft 74.

The second movable bracket 72 is sleeved on the connection shaft 74, is located between the first movable bracket 71 and the connection member 73, and is rotatably connected to the connection shaft 74.

The first movable bracket 71 and the second movable bracket 72 can rotate relative to the connection member 73 around the connection shaft 74. The first movable bracket 71 and the second movable bracket 72 can also relative to each other around the connection shaft 74.

The connection member 73 is connected to the puzzle board body 10. The first movable bracket 71 and the second movable bracket 72 are movably connected to the connection member 73 respectively and rotate through the connection shaft 74 sleeved on the connection member 73. This design uses the stability of shaft connection. The connection shaft 74, as a core rotating component, closely cooperates with the first movable bracket 71 and the second movable bracket 72. Since the first movable bracket 71 is sleeved on the connection shaft 74 and is rotatably connected to the connection shaft 74, while the second movable bracket 72 is also sleeved the connection shaft 74 and is disposed between the first movable bracket 71 and the connection member 73. In this nested structure, when the first movable bracket 71 and the second movable bracket 72 are subjected to a force, the connection shaft 74 can uniformly disperse the force to the connection member 73 and then transmits the force to the puzzle board body 10, to ensure the stability of connection and avoid component looseness or damage due to a non-uniform force during use.

The first movable bracket 71 and the second movable bracket 72 can rotate relative to the connection member 73 around the connection shaft 74, respectively, and can also rotate relative to each other around the connection shaft 74. By setting a relative position and degrees of freedom of rotation of different movable brackets on the same connection shaft 74, various combined rotation manners are provided for the bracket assembly 70. For example, when the inclination angle of the puzzle board body 10 needs to be adjusted, the first movable bracket 71 can rotate independently around the connection shaft 74. During the adjustment of the object placement position 80, the second movable bracket 72 can rotate relative to the connection member 73 or the first movable bracket 71, or they can rotate cooperatively to meet a diversification need for the function of the puzzle board function in different scenarios. That is, the independent or combined rotation of the first movable bracket 71 and the second movable bracket 72 greatly enriches the functional adjustment dimension of the puzzle board.

In Embodiment 1 of the present disclosure, an insertion slot 81 corresponding to the connection member 73 is provided in a top end of the puzzle board body 10. Connection between the bracket assembly 70 and the puzzle board body 10 is achieved by inserting the connection member 73 into the insertion slot 81.

The connection member 73 is of a plugboard structure.

The insertion slot 81 corresponding to the connection member 73 is provided in the top end of the puzzle board body 10, and the connection member 73 with the plugboard structure is inserted into the insertion slot 81 to achieve the connection between the bracket assembly 70 and the puzzle board body 10. This is a modular connection design concept. The shape and size of insertion slot 81 match with the shape and size of a plugboard. A stably connected structure is formed by the tight fit of the plugboard inserted into the insertion slot 81. In this design, the bracket assembly 70 is used as an independent module. By simple insertion and removal actions, assembling to or removal from the puzzle board body 10 can be achieved, thus facilitating component assembling during production and also facilitating separate maintenance or replacement of the bracket assembly 70 in the later stage.

The insertion slot 81 is provided in the top end of the puzzle board body 10, to provide a clear insertion position and direction guidance for the plugboard. When the plugboard structure is inserted into the insertion slot 81, an edge of the insertion slot 81 plays a guiding role, thus ensuring that the plugboard can be accurately inserted. After the plugboard is inserted in place, the cooperation between the insertion slot 81 and the plugboard can fix the bracket assembly 70, so that the first movable bracket 71 and the second movable bracket 72 are in correct positions in an initial state. This facilitates subsequent angle adjustment and other operations, and ensures normal implementation of the function of the entire puzzle board.

In Embodiment 1 of the present disclosure, after the connection member 73 is inserted into the insertion slot 81 of the puzzle board body 10, the first movable bracket 71 and the second movable bracket 72 are fixed to the top end of the puzzle board body 10.

The first movable bracket 71 can support the puzzle board body 10 after rotation. After rotation, the second movable bracket 72 cooperates with the top end of the puzzle board body 10 to form the object placement position 80.

After the connection member 73 is inserted into the insertion slot 81 of the puzzle board body 10, the first movable bracket 71 and the second movable bracket 72 are fixed to the top end of the puzzle board body 10. This design constructs an integrated structural system. The fixation of the connection member 73 inside the insertion slot 81 ensures that the first movable bracket 71 and the second movable bracket 72 form a stable connection relationship with the top end of the puzzle board body 10, to form a whole. After rotation, the first movable bracket 71 can support the puzzle board body 10. After rotation, the second movable bracket 72 cooperates with the top end of the puzzle board body 10 to form the object placement position 80. This is a design concept based on functional synergy. The first movable bracket 71 and the second movable bracket 72 are fixed by the same connection member 73 and have different functions. The first movable bracket 71 changes a placement angle of the puzzle board body 10 by rotation, and adjusts, based on the lever principle, a degree of inclination of the puzzle board body 10 by using a connection point to the connection member 73 as a fulcrum. By rotation, the second movable bracket 72 cooperates with the top end of the puzzle board body 10 at a specific position, to construct, by shape complementation, position alignment, and the like, a space (such as a mobile phone support) suitable for placing an object. To meet different needs of users during puzzle assembling, specifically, the second movable bracket 72 can rotate upward to form, with an edge or a corresponding groove position of the top end of the puzzle board body 10, the object placement position 80 that can support a mobile phone or another device.

In Embodiment 1 of the present disclosure, the puzzle board body 10 can be folded in half, and the insertion slot 81 corresponds to a folding position of the puzzle board body 10.

Specifically, for example, the puzzle board body 10 is provided with a hinge structure (a hinge) along its central axis, so that the puzzle board body 10 can be folded in half.

The puzzle board body 10 can be folded in half, and the insertion slot 81 corresponds to the folding position of the puzzle board body 10. This design fully considers the convenience of removal of the bracket assembly 70 before folding. The insertion slot 81 is provided in the folding position. When the puzzle board body 10 needs to be folded, a user can easily pull out the connection member 73 with the plugboard structure from the insertion slot 81, and then remove the bracket assembly 70. In this design, due to the simplicity of insertion and removal of the connection member 73 into and from the insertion slot 81, the removal operation can be completed without a complex tool, thus lowering the difficulty of user operation, ensuring a smooth folding process, and avoiding the obstruction of the folding action by the bracket assembly 70.

The insertion slot 81 is provided in the folding position. When the puzzle board body 10 is in an unfolded state, the bracket assembly 70 can be mounted at this position to achieve efficient spatial use. From the perspective of spatial layout, the folding position is relatively flat during unfolding, thus providing a suitable foundation for the mounting of the bracket assembly 70. When folding is required, after the bracket assembly 70 is removed, the folding position can naturally fit, without a large gap or being out of flatness caused after the folding by the insertion slot 81 or other structures, thus ensuring the compactness of the puzzle board body 10 after folding and effectively saving the storage space.

In Embodiment 1 of the present disclosure, after the connection member 73 is connected to the puzzle board body 10, when the puzzle board body 10 is in an unfolded state, the puzzle board body 10 is constrained to suppress a degree of freedom of rotation of the puzzle board body around the folding axis, to maintain stability of unfolding of the puzzle board body 10.

After the connection member 73 is connected to the puzzle board body 10 and the puzzle board body 10 is in the unfolded state, the puzzle board body is constrained to suppress the degree of freedom of rotation around the folding axis. After the connection member 73 is inserted into the insertion slot 81 corresponding to the folding position, the connection member can generate, through its own shape and size, and the tight fit with the insertion slot 81, resistance in a direction of possible rotation around the folding axis of the puzzle board body 10. For example, the connection member 73 with the plugboard structure is in the insertion slot 81, and its side surface is in tight fit with the inner wall of the insertion slot 81. When there is an external force that causes the puzzle board body 10 to rotate around the folding axis, a frictional force between the connection member 73 and the insertion slot 81, and structural resistance of the mutual fit between them jointly prevent the rotation of the puzzle board body 10, thereby maintaining the stability of unfolding of the puzzle board body 10.

From the perspective of structure, when the puzzle board body 10 is unfolded for use, especially when the bracket assembly 70 plays a role in supporting or when the object placement position 80 is constructed, there may be a trend of rotation in a folding direction due to non-uniform force distribution. In this case, the connection member 73 plays a role in stabilizing the structure, and its connection with the puzzle board body 10 is like adding a stable defense line at the folding axis. By constraining the rotation of the puzzle board body 10 around the folding axis, it ensures the rigidity of the entire puzzle board structure in the unfolded state and avoids deformation of the puzzle board or inability to function normally due to accidental rotation, so that the puzzle board body 10 can always maintain a stable working plane, thus preventing displacement of puzzle pieces due to shaking or rotation of the puzzle board during puzzle assembling, also avoiding sliding of placed objects, enhancing the safety and reliability of use.

In Embodiment 1 of the present disclosure, a storage slot 82 is further provided in the top end of the puzzle board body 10. The storage slot 82 is configured to store the first movable bracket 71 and the second movable bracket 72. The insertion slot 81 is located inside the storage slot 82.

The storage slot 82 is provided in the top end of the puzzle board body 10 to store the first movable bracket 71 and the second movable bracket 72, and the insertion slot 81 is located inside the storage slot 82. This is based on a design concept of space integration and utilization. The storage slot 82 fully uses an idle space of the top end of the puzzle board body 10, and intensively stores the bracket assembly 70 and the connection member 73 that are originally separated. When the puzzle board is not used, or only one of the first movable bracket 71 and the second movable bracket 72 is used, or both of them are not used, a user can orderly place corresponding idle components into the storage slot 82. For example, if only the first movable bracket 71 is used to support the puzzle board, the second movable bracket 72 can be stored in the storage slot 82. Meanwhile, the insertion slot 81 is disposed within the storage slot 82, thus achieving integration of storage and connection functional regions. During the mounting and removal of the bracket assembly 70, an operation space is centralized, making it convenient for operation by a user.

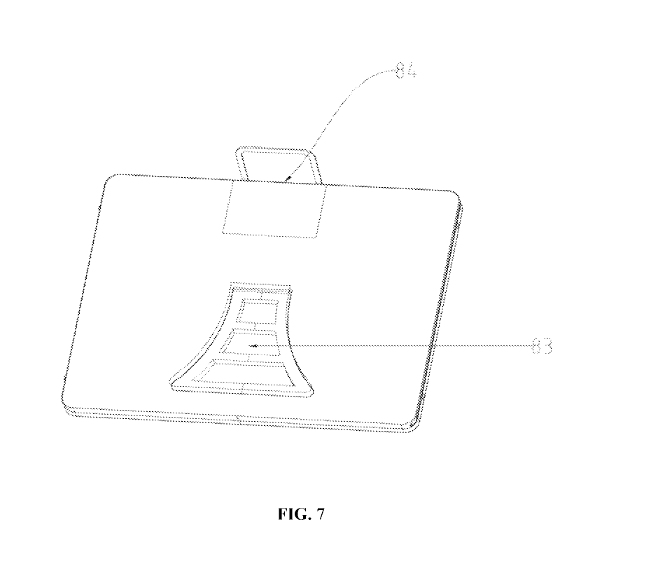

Referring to FIG. 7, in one embodiment of the present disclosure, the puzzle board body 10 is provided with a first connection position 83 and a second connection position 84. The first movable bracket 71 is movably connected to the first connection position 83, and the second movable bracket 72 is movably connected to the second connection position 84.

Different from the manner in which the first movable bracket 71 and the second movable bracket 72 are jointly connected to the same connection member 73, this design achieves separate mounting of the first movable bracket 71 and the second movable bracket 72 by disposing the first connection position 83 and the second connection position 84 on the puzzle board body 10. The second movable bracket 72 is still arranged at the top end of the puzzle board body 10 and can be movably connected to the puzzle board body 10 in a common shaft connection manner. After rotation, the second movable bracket 72 cooperates with the puzzle board body 10 to form the object placement position 80. The first movable bracket 71 is arranged at a middle position of a back portion of the puzzle board body 10 (or at other suitable positions). By using the shaft connection manner, the first movable bracket 71 can rotate around a shaft to support the puzzle board body 10. Due to connection positions and structural design of the components in this connection manner, the puzzle board body 10 cannot be folded in half, but it has unique advantages in aspects of bracket mounting, functional implementation, and structural stability. For example, the independent mounting of the brackets reduces mutual interference, and the connection design of specific positions is more suitable for function implementation.

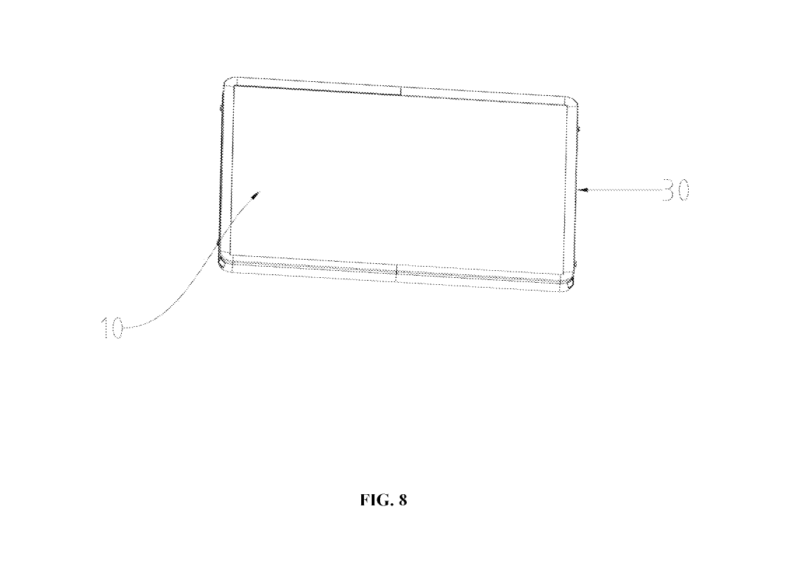

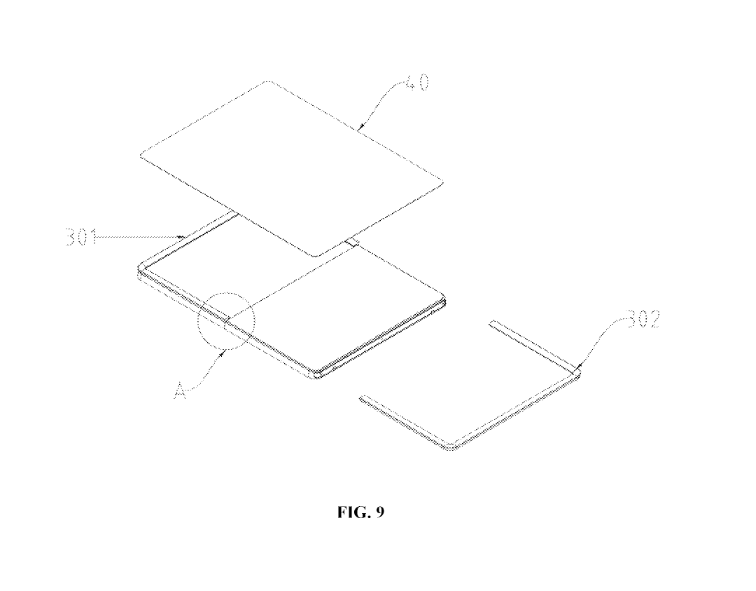

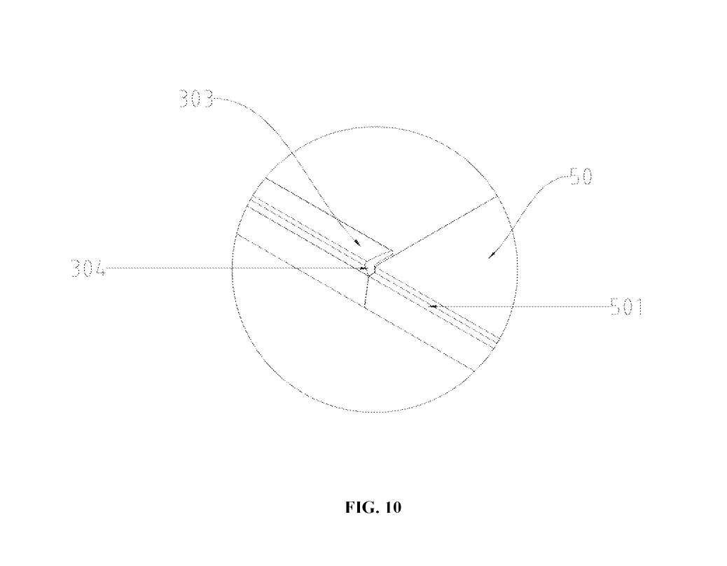

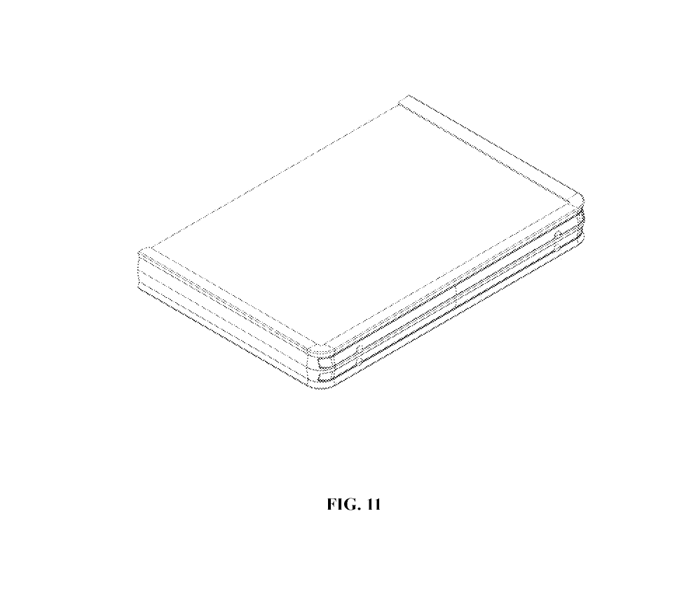

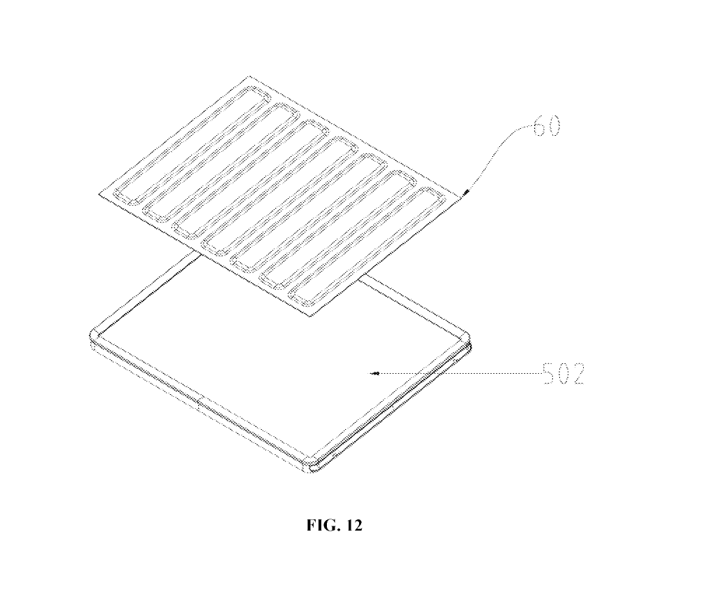

Referring to FIGS. 8 to 12, in Embodiment 2, a puzzle board with a magnetic attraction rim includes a puzzle board body 10 and a rim 30 detachably connected to the puzzle board body 10. A working layer 40 for assisting in doing a puzzle is arranged on a surface of the puzzle board body 10. The rim 30 is configured to compress the working layer 40 to achieve fixation of the working layer 40.

In the technical solution of Embodiment 2, the working layer 40 is disposed on the surface of the puzzle board body 10. It is a key part that is in direct contact with puzzle pieces and assists in a puzzle assembling operation. From the perspective of materials, a common material of the working layer 40, such as a felt, has a unique surface characteristic. A fiber structure on a surface of the felt can provide a frictional force for puzzle pieces, so that the puzzle pieces can relatively stably stay on the surface of the working layer 40 in a assembling process and cannot slide randomly. This is of vital importance for smooth assembling. Furthermore, the working layer 40 forms an organic entire structure with the puzzle board body 10 and the rim 30. The entire structure is placed on a surface of the puzzle board body 10, and the rim 30 surrounds an edge of the working layer 40 and compresses and fixes the working layer 40. This structural design ensures that the working layer 40 maintains a stable position throughout the puzzle assembling process, without displacement or wrinkling due to factors such as vibrations and collisions during operation, thereby providing a stable foundation for the puzzle assembling operation.

By using the rim 30 detachably connected to the puzzle board body 10, a flexible structural system is constructed. This design allows a user to conveniently separate the rim 30 from the puzzle board body 10 when needed, thereby implementing easy access and operation of the working layer 40 located on the surface of the puzzle board body 10. The principle is to use the detachable connection manner to break a traditional fixing mode of integrating the rim 30 of the puzzle board with the working layer 40, thus creating conditions for operations such as replacing the working layer 40. The function of the rim 30 is not only for decoration or simple enclosure, but also more importantly, to compress the working layer 40. When the rim 30 is connected to the puzzle board body 10, an appropriate pressure application manner (such as the weight of the rim 30 itself, and a pressure and force that are generated by a connection structure) ensures that the working layer 40 firmly abuts against the surface of the puzzle board body 10, to prevent displacement, wrinkling, and other situations of the working layer 40 that affect the puzzle assembling operation during use, and ensure the stability of the working layer 40 in the puzzle assembling process.

### Overall, Embodiment 2 can effectively:

Address the issue that the working layer 40 is non-replaceable: In response to the problem that the felt of the traditional felt puzzle board cannot be replaced because of glue adhesion. By using the detachable rim 30 of this design, a user can easily remove the rim 30 when a puzzle is adhered to the felt or the felt has other usable conditions, and remove an old working layer 40, and replace it with a new working layer 40. This design effectively avoids a situation in which the entire puzzle board needs to be discarded due to damage to the working layer 40 or puzzle adhesion, thus greatly saving resources and reducing usage costs of a user.

Mitigate the problem of a decrease in a frictional force: As the usage time increases, the frictional force of the working layer 40 will gradually decrease. In this design, when the frictional force of the working layer 40 (such as the felt) decreases and affects the puzzle assembling operation, a user can replace the working layer 40 with a new working layer 40 by removing the rim 30. The new working layer 40 has a good initial frictional force and can provide a stable support for puzzle pieces. This significantly enhances the stability and operation experience of a puzzle. Especially for a complex puzzle with a large number of puzzle pieces, it ensures that the puzzle pieces do not easily slide or move in the puzzle assembling process.

Deal with the problem of a cleaning difficulty: Since the felt material easily absorbs dust and hairs, and is hard for cleaning, by this design, through the removable rim 30, it is convenient for a user to regularly remove the working layer 40 for separate cleaning or to directly replace the working layer 40 with a new working layer 40. This not only maintains an attractive appearance of the puzzle board, but also maintains a good frictional force between puzzle pieces and the surface of the working layer 40, thus ensuring a smooth puzzle assembling operation and enhancing an overall usage effect of the puzzle board.

In Embodiment 2 of the present disclosure, the rim 30 is in magnetic attraction mating with the puzzle board body 10.

A magnetic attraction connection assembly is disposed between the puzzle board body 10 and the rim 30. Stable magnetic attraction mating between the rim 30 and the puzzle board body 10 is achieved through the magnetic attraction connection assembly.

The magnetic attraction connection assembly includes a permanent magnet component arranged at an edge of the puzzle board body 10, and a magnetic attraction mating component arranged at a corresponding position of the rim 30.

The permanent magnet component is a permanent magnet block or permanent magnet particles that are distributed, and the magnetic attraction mating component is a metal sheet or a magnetic rubber sheet that can be attracted by the permanent magnet component, or another magnet component with an opposite magnetic pole to the permanent magnet component.

By using the opposites attraction characteristics of magnetic materials, magnetic connection assemblies are respectively arranged at corresponding positions of the rim 30 and the puzzle board body 10. For example, a permanent magnet is embedded into the edge of the puzzle board body 10, and an attractable metal patch or a magnet with an opposite magnetic pole is mounted at the corresponding position of the rim 30. This design constructs a connection manner that does not require a complex mechanical structure. A user simply needs to place the rim 30 close to the puzzle board body 10, and a magnetic force can automatically guide and achieve quick connection between them. This greatly simplifies a mounting process of the rim 30 and enhancing the convenience of operation by a user.

Furthermore, magnetic attraction mating can adapt to small dimensional deviations or positional errors, which occur during manufacturing and mounting, of the puzzle board body 10 and the rim 30 to an extent. Since an action range of the magnetic force is flexible, when there is a small positional deviation between them, the magnetic force will automatically adjust the position of the rim 30 to accurately mate the rim 30 with the puzzle board body 10, thus ensuring that the working layer 40 is uniformly compressed and maintains a good working state.

Preferably, the detachable connection between the puzzle board body 10 and the rim 30 can also be snap-in connection, screw connection, or the like. It is not limited herein. In the present disclosure, the magnetic attraction mating is preferred, so that during use, a user can quickly complete the mounting and removal operations of the rim 30 by the hands, without an additional tool. For a user who frequently replaces the working layer 40, this characteristic greatly shortens the operation time and significantly enhances the usage efficiency.

In Embodiment 2 of the present disclosure, the working layer 40 is a felt layer which covers a surface of a region, which is used for assembling a puzzle, of the puzzle board body 10.

As mentioned above, the working layer 40 is the felt layer which has a unique fiber structure. Fibers are interwoven with each other to form an irregular surface. When puzzle pieces are placed on the surface of the felt layer, a high frictional force can be generated between the puzzle pieces and the felt fibers. Covering the surface of the region, which is used for assembling a puzzle, of the puzzle board body 10 provides a stable placement foundation for the puzzle pieces by using the frictional force.

The region, which is used for assembling a puzzle, of the puzzle board body 10 is a core part for the puzzle assembling operation. The felt layer accurately covers the region, which can be in tight fit with the contour of the surface of the puzzle board body 10, so that the space of the region is fully used, and a complete and suitable working plane is provided for a puzzle. Meanwhile, due to its flexibility, the felt material can better adapt to the slight roughness that may exist on the surface of the puzzle board body 10, thus further ensuring good contact with the puzzle pieces, enhancing the effect of the frictional effect, and ensuring a smooth assembling process.

In Embodiment 2 of the present disclosure, the puzzle board body 10 is provided with a hinge structure along its central axis, so that the puzzle board body 10 can be folded in half.

The rim 30 is correspondingly divided into a first half rim 301 and a second half rim 302 along a central axis of the puzzle board body 10.

A hinge structure (such as a hinge) is arranged along a central axis of the puzzle board body 10 to achieve the half folding of the puzzle board body 10. This design draws on the principle of common folding furniture, and achieves rotatable folding of a component through a hinge point. When the puzzle board is not in use or needs to be stored, a user can fold the puzzle board body 10 in half along the hinge structure, thus effectively reducing an occupation area of the puzzle board body 10 in a space. For a limited family space or a user who needs to frequently move the puzzle board, this design can flexibly adjust the spatial form of the puzzle board to meet requirements for spaces in different scenarios.

To cooperate with the folding function of the puzzle board body 10, the rim 30 is correspondingly divided into the first half rim 301 and the second half rim 302 along the central axis of the puzzle board body 10. This design ensures that the rim 30 can also adapt to it correspondingly when the puzzle board body 10 is folded. When the puzzle board body 10 is folded in half, the first half rim 301 and the second half rim 302 can approach and be docked with each other to continue to exert the compressing and fixing effect of the rim 30 on the working layer 40, while maintaining the integrity of the overall structure. The design principle is to synchronize and coordinate the folding actions on the rim 30 and the puzzle board body 10, thus maintaining the functional consistency of the product in different states.

Preferably, corresponding connection mechanisms can be designed at engagement positions of the first half rim 301 and the second half rim 302. For example, mutually matching magnetic attraction strips can be respectively arranged at edges, opposite to each other, of the first half rim 301 and the second half rim 302. By using the magnetic attraction principle, when the puzzle board body 10 is folded in half, the magnetic attraction strips automatically attract each other, so that the two half rims 30 are tightly connected to each other. The operation is simple and the connection is stable. Alternatively, the first half rim 301 and the second half rim 302 can be designed to be buckle type engagement structures. A raised buckle is arranged on the first half rim 301, and a recessed buckle slot is provided in a corresponding position of the second half rim 302. During folding, the raised buckle is accurately embedded into the recessed buckle slot to achieve reliable connection, thus preventing accidental separation of the two half rims 30 during movement or use. A design of reserving a gap can also be used. When the puzzle board body 10 is folded, the first half rim 301 and the second half rim 302 approach each other, but do not completely abut against each other, thus leaving a gap with a width. This design is mainly based on the considerations of thermal expansion and contraction of a material, and a production and manufacturing tolerance, at different ambient temperatures, a puzzle board material may experience thermal expansion and contraction, and the gap can provide a space for expansion and contraction of the material of the rim 30, thus preventing deformation or damage to the engagement position of the rim 30 due to the thermal expansion. Meanwhile, during the production and manufacturing, due to process limitations, there may be a slight deviation in the sizes of the half rims 30. The presence of the gap can effectively accommodate these tolerances, so that the two half rims 30 can still be smoothly docked in a folded state, to maintain the structural stability of the product. Moreover, during folding, the gap will not affect the compressing and fixing effect of the rim 30 on the working layer 40, while maintaining the integrity of the overall structure. The folding actions on the rim 30 and the puzzle board body 10 are synchronized and coordinated, thus maintaining the functional consistency of the product in different states.

In Embodiment 2 of the present disclosure, a convex platform structure 50 is arranged on a surface of the puzzle board body 10. An upper surface of the convex platform structure 50 forms a mounting plane of the working layer 40, and a stepped slot 501 matching with the rim 30 is provided around a periphery of the convex platform structure. The rim 30 can be embedded into the stepped slot 501.

The convex platform structure 50 is arranged on the surface of the puzzle board body 10, and the upper surface of the convex platform structure 50 is a placement region for the working layer 40. The convex platform separates the working layer 40 from other parts of the puzzle board body 10, thus mitigating the impact of structural changes in other parts of the body on the flatness of the working layer 40, providing a stable support for the working layer 40, and ensuring that the working layer 40 remains flat at all the time. The stepped slot 501 is provided around the periphery of the convex platform structure, and the size and shape of the stepped slot 501 match with those of the rim 30. During the mounting of the rim 30, the rim 30 is embedded (or snapped or placed) into the stepped slot 501, and the stepped slot 501 plays a role of positioning the rim 30. For the puzzle board using magnetic attraction connection, the rim 30 is first positioned through the stepped slot 501, and is then connected to the puzzle board body 10 by using the magnetic attraction connection assembly. The stepped slot 501 ensures that the rim 30 is accurately in place during the mounting, so that magnetic poles of the magnetic attraction connection assembly can be in correct correspondence, thereby enhancing the stability of magnetic connection and ensuring the compression effect of the rim 30 on the working layer 40.

In Embodiment 2 of the present disclosure, the rim 30 has a compression portion 303 and a connection portion 304 that are of an integrated structure.

The compression portion 303 corresponds to the mounting plane of the convex platform structure 50 on the surface of the puzzle board body 10 and is configured to compress the working layer 40 arranged on the mounting plane.

The connection portion 304 corresponds to a stepped slot 501 around a peripheral side of the convex platform structure 50 and is configured to be embedded into the stepped slot 501, to achieve stable connection between the rim 30 and the puzzle board body 10.

The compression portion 303 corresponds to the mounting plane of the convex platform structure 50 on the surface of the puzzle board body 10. Its design purpose is to provide a uniform and stable compression force for the working layer 40. When the rim 30 is mounted on the puzzle board body 10, the compression portion 303 directly acts on an edge position of the working layer 40. By using its own gravity and an elastic deformation pressure generated after mounting, the working layer 40 is tightly pressed on the mounting plane of the convex platform structure 50.

The connection portion 304 matches with the stepped slot 501 around the peripheral side of the convex platform structure 50, and can be embedded into the stepped slot 501 for preliminary positioning during mounting. Preferably, the magnetic attraction connection assembly can be arranged on the connection portion 304. For example, small magnets or magnetic attraction materials are distributed on an inner side surface of the connection portion 304. Correspondingly, a slot wall of the stepped slot 501 of the puzzle board body 10 is embedded with an attractable metal sheet or magnetic material. After the connection portion 304 is embedded into the stepped slot 501, the magnetic attraction assembly attracts each other to achieve magnetic connection. In this process, the connection portion 304 is stably attached into the stepped slot 501 under the action of a magnetic force, and at the same time, can transmit this stable force. Since the connection portion 304 and the compression portion 303 are of the integrated structure, the stability of the connection portion 304 can drive the compression portion 303 to act more tightly on the working layer 40, thus applying an addition pressure to the compression portion 303, to cause the compression portion 303 to better tightly press the working layer 40 on the mounting plane of the convex platform structure 50 to prevent the working layer 40 from moving or wrinkling.

In Embodiment 2 of the present disclosure, the rim 30 encloses a slot position 502 corresponding to the working layer 40, and a cover plate 60 that is detachably connected to the puzzle board body 10 is disposed on the slot position 502.

When no puzzle assembling operation is performed, the cover plate 60 tightly presses the working layer 40 in the slot position 502 to fix a puzzle on the working layer 40. Preferably, the cover plate 60 is in magnetic attraction mating with the puzzle board body 10.

The rim 30 encloses the detachable cover plate 60 in the slot position 502 corresponding to the working layer 40, with a main purpose of protecting a completed puzzle on the working layer 40 when no puzzle assembling operation is performed. When the cover plate 60 is placed in the slot position 502, the cover plate 60 can apply a pressure to the working layer 40 by relying on its own gravity and the magnetic force generated by the magnetic attraction mating with the puzzle board body 10. This pressure can effectively prevent puzzle pieces from moving or being scattered due to collisions with an external force, vibration, or accidental touch, and avoid damage to a puzzle or the working layer 40 due to an excessive pressure. The cover plate 60 is designed to be in magnetic attraction mating with the puzzle board body 10, thus using the convenience and stability of the magnetic force. When a user needs to mount or remove the cover plate 60, the user simply needs to slightly place the cover plate 60 close to or move the cover plate 60 away from the puzzle board body, thus achieving quick connection and separation. Meanwhile, the magnetic force can ensure that the cover plate 60 is accurately aligned with the slot position 502 during placement and maintains a stable pressure application state during use, to continuous provide reliable protection for a puzzle. The cover plate 60 can be a flexible board with a magnetic performance. The puzzle board body 10 is located inside an inner slot and is provided with a corresponding magnetic component (which is spatially distinguished from the permanent magnet component at the edge of the puzzle board body 10 to avoid a magnetic attraction conflict) that is mated with the cover plate 60.

This design is closely adapted to a puzzle assembling operation process. In the puzzle assembling process, a user can easily remove the cover plate 60 and put it aside, without causing any obstructions to the puzzle assembling operation. When assembling is temporarily interrupted or a part of a puzzle needs to be saved, the cover plate 60 can be quickly mounted in the slot position 502 through magnetic attraction to apply a moderate pressure to the puzzle on the working layer 40 for proper protection. This seamlessly connects different stages of puzzle assembling and provides a user with a convenient and efficient puzzle assembling experience.

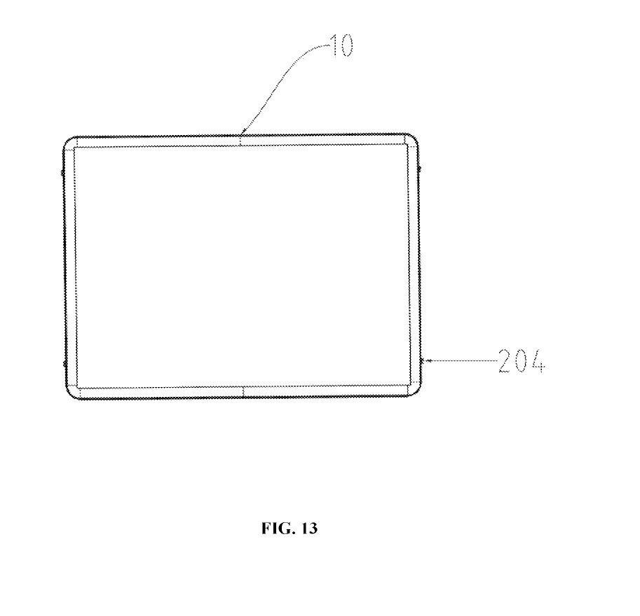

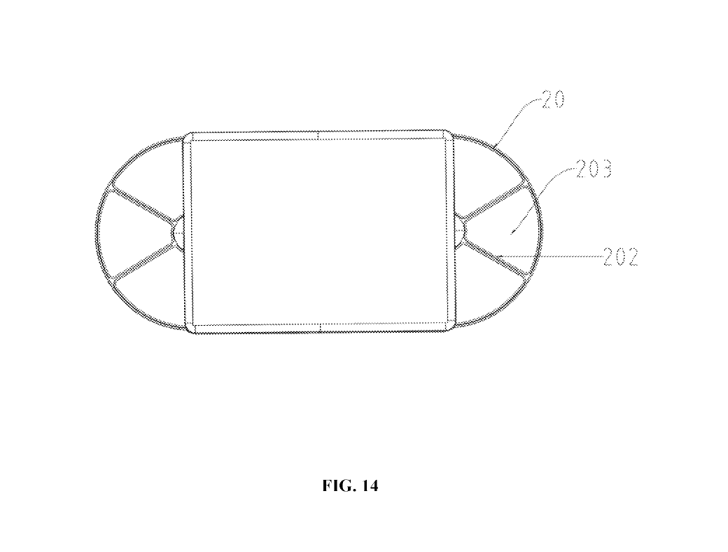

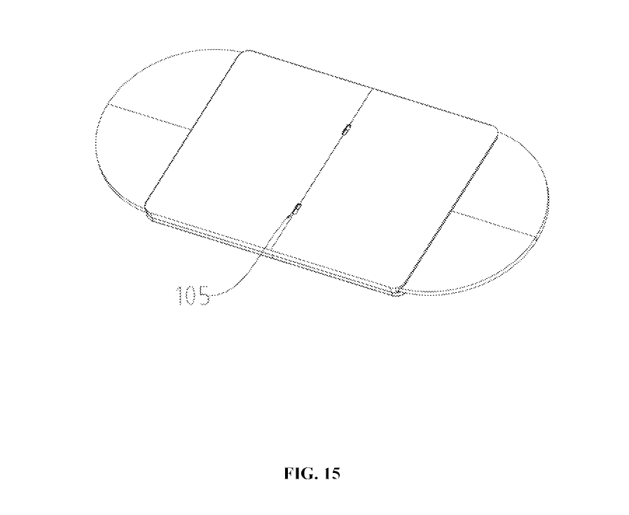

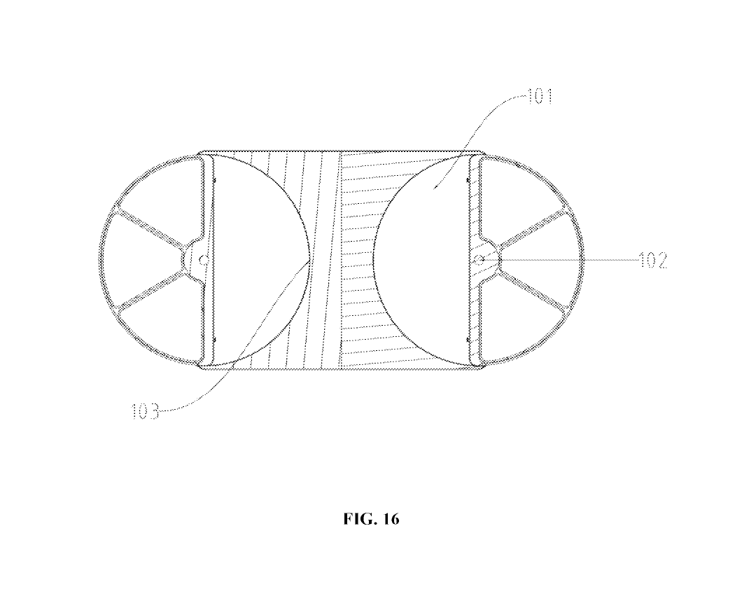

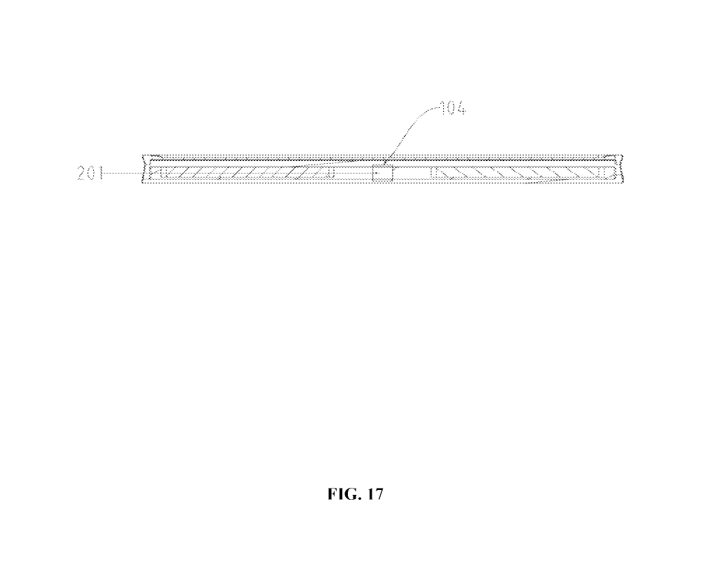

Referring to FIGS. 13 to 17, in Embodiment 3, a puzzle board with a rotatable drawer includes a puzzle board body 10. The puzzle board body 10 is provided with a rotatably connected drawer 20. The drawer 20 can extend out from or be stored into the puzzle board body 10 during rotation.

In the technical solution of Embodiment 3, the rotatably connected drawer 20 is added to the puzzle board body 10. From the perspective of a mechanical structure principle, the drawer 20 is connected to the puzzle board body 10 through a specific rotatable connection device, such as a hinge or a rotating shaft 102, so that the drawer 20 can move in a circular path around a connection point. This design allows the drawer 20 to flexibly switch positions between the inside and outside of the puzzle board body 10, thus providing a spatial foundation for puzzle piece storage.

The drawer 20 is designed to be rotatable, rather than a traditional linear pull-out type, so as to better adapt to a puzzle assembling scenario. Specifically, during puzzle assembling, a space around a player may be limited, and a linear pull-out drawer 20 may not be fully opened due to spatial obstructions, thus affecting the convenience of taking puzzle pieces. However, the rotatable drawer 20 only needs to occupy a relatively small arc-shaped space during rotation, and can smoothly extend out within a limited space, making it easier for the player to take the puzzle pieces. Meanwhile, a rotation action is more flexible than a linear pulling action, and the player can easily open the drawer 20 at different angles. This conforms to the ergonomic principles and lowers the difficulty of operation.

### Overall, Embodiment 3 can effectively:

Address the problem of puzzle piece storage: The puzzle board effectively solves the problem that the traditional puzzle board lack a puzzle piece storage function. A player no longer needs to search for an additional container to store puzzle pieces, and can directly classify and place the puzzle pieces into the drawer 20. By storage through the drawer 20, the puzzle pieces are stored intensively, thus greatly lowering a risk of scattering and loss of the puzzle pieces, and avoiding a situation in which a puzzle cannot be completed due to missing puzzle pieces. For example, at a family gathering, when many people participate in a puzzle game, the puzzle board with the rotatable drawer 20 allows everyone to easily store puzzle pieces into the drawer. Even if the game is interrupted, people do not worry about the puzzle pieces being lost due to confusion.

Enhance the puzzle assembling experience: During assembling, the rotatable drawer 20 makes it convenient for a player to quickly locate a desired puzzle piece. The player can classify and place the puzzle pieces into different regions of the drawer 20 or into different drawers 20 based on shapes, colors, and other features of the puzzle pieces. When needed, corresponding puzzle pieces can be quickly found out, instead of searching a large number of disordered puzzle pieces one by one, thus saving the time, maintaining the coherence of the puzzle assembling thinking, and enhancing the smoothness and fun of a puzzle game. For example, to complete a complex puzzle with thousands of puzzle pieces, the rotatable drawer 20 can allow the player to quickly find out edge puzzle pieces or specific pattern puzzle pieces, to accelerate the puzzle assembling progress.

Save the space and facilitate storage: After the puzzle game is over, the rotatable drawer 20 can be stored inside the puzzle board body 10, to reduce the overall space occupation. Compared with the traditional manner in which the puzzle board is provided with an additional storage container, this integrated design is more convenient for daily storage, especially suitable for users with limited living spaces. Whether the puzzle board is placed on bookshelves, in cabinets, or under tables, the space can be effectively saved, and the home environment is tidier and more orderly.

In Embodiment 3 of the present disclosure, the puzzle board body 10 is provided with a built-in slot 101 configured to store the drawer 20. The drawer 20 is rotatably connected to the puzzle board body 10 through a rotating shaft 102, so as to be able to extend out from the built-in slot 101 around the rotating shaft 102 or be stored into the built-in slot 101.

The provision of the built-in slot 101 for storing the drawer 20 is based on the considerations of efficient space utilization and stable storage of the drawer 20. From the perspective of the space design, the size of the built-in slot 101 and the size of the drawer 20 precisely match with each other to ensure that the drawer 20 that is in a stored state can perfectly fit with the puzzle board body 10. This not only implements a neater overall appearance of the puzzle board, but also effectively avoids the impact of random shaking of the drawer 20 that is not in use on the stability of placement of the puzzle board. Meanwhile, the presence of the built-in slot 101 provides an exclusive storage space for the drawer 20, so that a space occupied by the entire puzzle board that is not in use is only equal to an area of the puzzle board body 10, and space utilization is maximized.

The rotating shaft 102 is used to rotatably connect the drawer 20 to the puzzle board body 10 to achieve a stable and flexible rotation operation on the drawer 20. As a core connection component, the rotating shaft 102 has good rotation performance and can withstand the weight and external force of the drawer 20 during rotation. By mounting the rotating shaft 102 in a preset position, the drawer 20 can move in a circular path around the rotating shaft 102, so as to smoothly extend out from or be stored back into the built-in slot 101. Compared with other connection manners such as simple hinge connection, this connection manner can better ensure the stability of the drawer 20 during rotation, reduce shaking and shift, and provide a user with a reliable operation experience.

In Embodiment 3 of the present disclosure, a central hole 201 is formed in a center position of the drawer 20. Two ends of the built-in slot 101 correspond to the position of the central hole 201 of the drawer 20, and are respectively provided with shaft holes 104 matching with the rotating shaft 102. The rotating shaft 102 passes through the shaft hole 104 in one end, the central hole 201 of the drawer 20, and the shaft hole 104 in the other end in sequence.

The shaft holes 104 matching with the rotating shaft 102 are formed in positions, corresponding to the center position of the drawer 20, at the two ends of the built-in slot 101, so as to achieve precise positioning of the drawer 20 for mounting. From the perspective of a mechanical mounting principle, the precise matching between the shaft holes 104 and the rotating shaft 102 ensures that the rotating shaft 102 can be mounted along a specific trajectory, and the drawer 20 can rotate stably around the provided central axis after being mounted. Forming the shaft holes 104 in the positions corresponding to the center of the drawer 20, a uniform force on the drawer 20 during rotation is ensured, thus avoiding shaking or jamming occurring during rotation of the drawer 20 caused by a mounting deviation and laying a foundation for the stable operation of the drawer 20. The rotating shaft 102 passes through the shaft hole 104 in one end, the central hole 201 of the drawer 20, and the shaft hole 104 in the other end in sequence, thus forming a stable rotatable support structure. The tight fit between the shaft holes 104 and the rotating shaft 102 not only provides a fulcrum of rotation for the drawer 20, but also withstands various action forces generated by the drawer 20 during rotation, including the gravity, an inertia force, an external force applied by a player during operation, and the like. This design ensures that the drawer 20 can always maintain a stable rotating state during frequent opening and closing, thus ensuring the normal use of the puzzle board.

In Embodiment 3 of the present disclosure, the drawer 20 is of a semicircular structure capable of rotating around the rotating shaft 102 serving as a center.

The built-in slot 101 is in a semicircular shape matching with the drawer 20.

The drawer 20 is designed to be of the semicircular structure capable of rotating around the rotating shaft 102, and the built-in slot 101 is in the semicircular shape matching with the semicircular structure. It is based on the considerations of efficient space utilization and structural matching. Specifically, from the perspective of a spatial design principles, the semicircular structure can maximize the use of the region of the built-in slot 101 for puzzle piece storage within a limited space of the puzzle board body 10. Compared with a design in which the drawer 20 and the built-in slot 101 are square or in another shape, the semicircular structure can better fit a contour of an internal space of the puzzle board and reduce the space waste. Moreover, this adaptive shape design causes the drawer 20 to be in closer and smoother contact with the built-in slot 101 during rotation, thus ensuring the stability and smoothness of rotation of the drawer 20.

The design of the semicircular drawer 20 using the rotating shaft 102 as the center conforms to the principle of rotational dynamics. Specifically, the center of gravity of the semicircular shape is relatively uniformly distributed. This can reduce shaking and resistance due to an offset in the center of gravity during rotation around the rotating shaft 102. When a player pushes the drawer 20 to rotate, the semicircular structure applies the force to the rotating shaft 102 more intensively, thus reducing the force required for operation and enhancing the convenience of operation. Meanwhile, the semicircular design of the built-in slot 101 also provides a suitable space range and guidance for the rotation of the drawer 20. This further optimizes the rotation performance of the drawer 20.

In Embodiment 3 of the present disclosure, an arc-shaped track 103 is arranged on an inner wall of the built-in slot 101. An outer contour of the drawer 20 abuts against the arc-shaped track 103, so that the drawer 20 can steadily slide along the arc-shaped track 103 when rotating around the rotating shaft 102.

The arc-shaped track 103 is arranged on the inner wall of the built-in slot 101. This design is to provide a precise sliding guidance and a stable support for the rotation of the drawer 20. From the perspective of a mechanical motion principle, the fitness between the arc-shaped track 103 and the outer contour of the drawer 20 can ensure that the drawer 20 always moves along a provided arc-shaped trajectory during rotation around the rotating shaft 102. This guiding effect prevents the drawer 20 from shifting or shaking during rotation, thus ensuring the stability of operation of the drawer 20. Meanwhile, the arc-shaped track 103 can disperse a pressure on the drawer 20 during rotation and provide a continuous and uniform support force, to cause the drawer 20 to rotate more smoothly and effectively mitigate a jamming phenomenon caused by a non-uniform local force.

When the outer contour of the drawer 20 fits and slides along the arc-shaped track 103, a frictional force generated between them is more stable and controllable compared with a case without a track. An appropriately-designed arc-shaped track 103 can reduce the friction coefficient, decrease the resistance when the drawer 20 rotates, and make it easier for a player to push the drawer 20. From the perspective of a frictional force principle, the surface contact between the arc-shaped track 103 and the drawer 20 can better distribute the frictional force compared with point contact or linear contact, thus avoiding wear on the drawer 20 and the track due to an excessive local frictional force, thereby enhancing the overall motion performance and service life of the drawer 20.

In Embodiment 3 of the present disclosure, the puzzle board body 10 is provided with a hinge structure 105 along its central axis, so that the puzzle board body 10 can be folded in half.

Two drawers 20 are included, which are respectively arranged in built-in slots 101 at two ends of the puzzle board body 10. When the puzzle board body 10 is folded in half through the hinge structure 105, the two drawers 20 are stored into the corresponding built-in slots 101 and approach each other.

The hinge structure 105 is arranged along the central axis of the puzzle board body 10 to meet a demand of a user for portability of the puzzle board. From the perspective of the product design concept, through the hinge structure 105 (such as a hinge), the puzzle board can be folded in half, thus greatly reducing an occupation area when not in use. When the user needs to go out with the puzzle board, such as participating in outdoor picnics, parent-child activities, or traveling, the foldable design makes it easy for the user to put the puzzle board into a backpack, a handbag, or the like. This facilitates transportation and storage. Meanwhile, the two drawers 20 are respectively located inside the built-in slots 101 at the two ends of the puzzle board body 10, and approach each other for storage when the puzzle board is folded. This further optimizes the space utilization. The design fully considers a storage need for puzzle pieces. In a limited space of the puzzle board, by properly designing the positions of the drawers 20, a storage volume is maximized, while ensuring the stability of the drawers 20 and the puzzle pieces inside the drawers in a folded state.

In Embodiment 3 of the present disclosure, a plurality of partition structures 202 are disposed within each drawer 20 to partition the inside of the drawer 20 into a plurality of independent storage regions 203 through the plurality of partition structures 202.

Disposing the plurality of partition structures 202 within each drawer 20 is to meet an actual need for classified management of puzzle pieces in an assembling process. The puzzle pieces generally have different shapes, colors, and patterns. In the puzzle assembling process, a player needs to quickly find out particular puzzle pieces. By dividing the interior of each drawer 20 into the plurality of independent storage regions 203 through the partition structures 202, the player can conduct classified storage on the puzzle pieces based on their features. This design draws on a partitioning concept in warehouse management: properly planning an originally disordered puzzle piece storage space. Each region has its particular function, thereby enhancing the puzzle piece management efficiency.

From the perspective of space utilization, the arrangement of the partition structures 202 optimizes the internal spatial layout of the drawer 20. Puzzle pieces that are in different sizes and shapes can be adaptively placed based on sizes of partitioned regions, thus avoiding cluttering of the puzzle pieces inside the drawer 20. Each partitioned region functions as a relatively independent storage unit, so that an inner space of the drawer 20 is fully and properly used. This orderly spatial planning not only helps enhance the storage efficiency, but also can reduce mutual squeezing and collisions between the puzzle pieces and protect the puzzle pieces from being damaged.

In Embodiment 3 of the present disclosure, the partition structures 202 are placement trays, and shapes of the placement trays match with an inner contour of the drawer 20.

The placement trays can be removed from the drawer 20.

The partition structures 202 are designed as the placement trays matching with the inner contour of drawer 20 in shape, so that the partition structures can be removed from the drawer 20, to meet a flexible need of a user for a storage manner and personalized customization. Since different users may have different standards for classifying puzzle pieces during puzzle assembling, the removable placement trays allow the users to freely adjust a size and layout of each storage region 203 based on their own habits. For example, for a complex human figure puzzle, some users may hope to separately place puzzle pieces of different human figures in the independent placement rays, while others may classify and place the puzzle pieces based on colors of the puzzle pieces. This design allows users to make decisions by their own, thus greatly enhancing the flexibility of a storage manner and better conforming to personalized puzzle assembling habits of the users.

From the perspective of usage convenience and maintenance of the product, the design of the removable placement trays makes cleaning easier. During assembling, the placement trays are easily contaminated by dust, stains, and the like. Especially in a home scenario in which children participate in doing a puzzle, as a placement tray may become soiled by food residues, the removable design allows a user to directly remove the placement tray from the drawer 20 for separate cleaning, thus avoiding the inconvenience of cleaning the interior of the drawer 20. This ensures that a storage space remains consistently clean and tidy, and provides a good storage environment for the puzzle pieces.

Meanwhile, the characteristic that a placement tray can be removed independently significantly enhances the convenience of instant use of the puzzle board. Specifically, a player can directly play a puzzle game while holding the placement trays with corresponding puzzle pieces.

In a further solution of Embodiment 3 of the present disclosure, to achieve precise positioning and stable fixation of the drawer 20 in the stored state, magnetic attraction structures are provided at the drawer 20 and an opening of the built-in slot 101. Specifically, a permanent magnet is embedded into an edge position of the opening of the built-in slot 101, and a metal patch mutually attracting the permanent magnet or a magnet with an opposite magnetic pole is mounted on an outer edge of the corresponding drawer 20. When the drawer 20 is stored into the built-in slot 101, an attraction force between opposite magnetic poles takes effect, to attract the drawer 20 in its predetermined position, thus effectively enhancing the stability of the drawer 20 during storage.

Preferably, a handle 204 is also arranged on an outer side of the drawer 20 in the stored state, to make it convenient for a player to operate the drawer 20 for rotation and storage or extension.

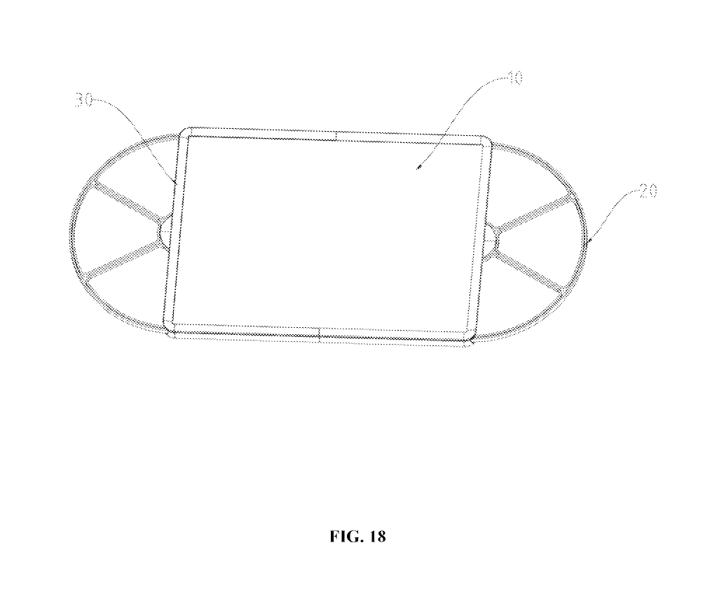

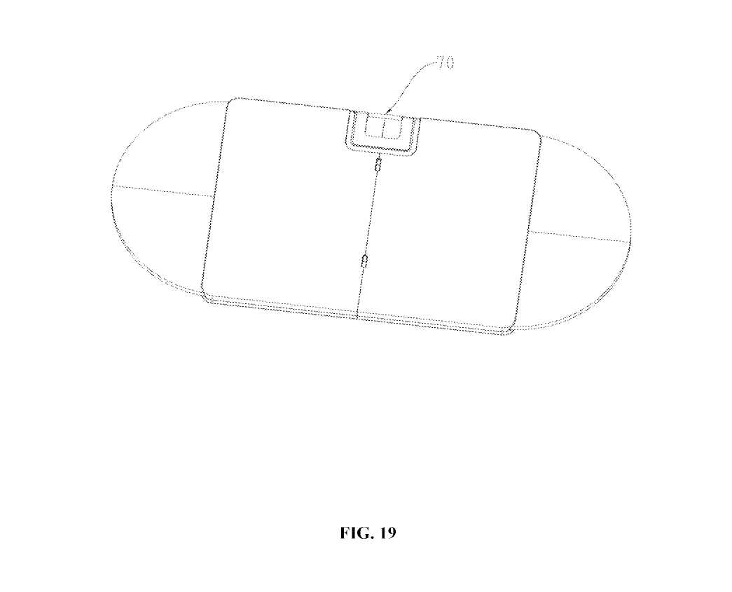

Referring to FIGS. 18 to 19, in the present disclosure, a puzzle tool integrated with multifunctional features, including a bracket assembly 70, a magnetic attraction rim 30, and a rotatable drawer 20 is provided.

The bracket assembly 70 adjusts an inclination angle of a puzzle board body 10 based on a lever principle by rotating a first movable bracket 71, thereby effectively enhancing the light reflection, reducing the visual interference, alleviating the neck fatigue of a user caused by long-time head lowering, and enhancing the puzzle assembling efficiency. A second movable bracket 72 can rotate independently or relatively and cooperates with the puzzle board body 10 to form an object placement position 80, thus facilitating placement of a device such as a mobile phone or a tablet, and significantly enhancing the usage convenience. Meanwhile, the bracket assembly 70 is securely connected to the puzzle board body 10. By using a connection member 73 and a shaft connection manner, a force is uniformly dispersed, thus guaranteeing the reliability of connection, while facilitating daily mounting, removal, maintenance, and storage.

The magnetic attraction rim 30 uses a magnetic attraction connection assembly to achieve quick and stable connection with the puzzle board body, thus simplifying a mounting process, while automatically compensating for small dimensional deviations during manufacturing and mounting. A working layer 40 made of a felt material provides a sufficient frictional force for puzzle pieces by its fibrous structure, thus ensuring the stability during puzzle assembling. In addition, a convex platform structure 50 cooperates with the rim 30 to effectively compress the working layer 40. When no puzzle assembling operation is performed, a magnetic attraction cover plate 60 protects a completed puzzle section on the working layer 40.

The rotatable drawer 20 can flexibly extend out or be stored within a limited space by using a rotatable connection structure of a rotating shaft 102, thus effectively solving a problem that it is difficult to store puzzle pieces of a traditional puzzle board and lowering a risk of scattering and loss of the puzzle pieces. The design in which the drawer 20 and a built-in slot 101 are semicircular efficiently uses the space. This conforms to the principle of rotational dynamics for smooth and stable operation. An interior of the drawer 20 is divided into a plurality of independent storage regions 203 through partition structures 202, thus meeting a need of a user for classified management of puzzle pieces, and optimizing the spatial layout. The design of removable placement trays further enhances the flexibility of storage. It is convenient for adjustment by a user based on an own habit and convenient for cleaning. In addition, magnetic attraction structures at the drawer 20 and an opening of a built-in slot 101 enhance the storage stability, while a handle 204 on an outer side facilitates operation on drawer 20 for rotation, storage, or extension.

The three major functional modules, namely the bracket assembly 70, the magnetic attraction rim 30, and the rotatable drawer 20, are independent and complementary. The modules leverage their own advantages, without interfering with other functions, and jointly create the puzzle tool with convenience and functionality, thus fully meeting diverse needs of modern users for puzzles in different scenarios.

### In addition:

The core design of foldability of the puzzle board body 10 achieves perfect cooperation among the three major functional modules, namely the bracket assembly 70, the magnetic attraction rim 30, and the rotatable drawer 20. Specifically, the puzzle board body 10 can be folded in half along the central axis, thus significantly enhancing the portability and the storage convenience. The insertion slot 81 of the bracket assembly 70 corresponds to the folding position, so that it is easy for removal, without obstructions. During unfolding, the connection member 73 is inserted into the insertion slot 81 to suppress rotation around the folding axis. This ensures the first movable bracket 71 can adjust an angle to enhance lighting and alleviate the neck fatigue, and the second movable bracket 72 constructs the placement position, is securely connected, and facilitates maintenance. The magnetic attraction rim 30 is divided into two halves along the central axis, and continuously compresses the felt working layer 40 when folded, to maintain stable functionality. Meanwhile, the magnetic attraction assembly ensures quick connection, and the convex platform cooperates with the rim 30 for compression. The magnetic attraction cover plate 60 protects a completed section. The rotatable drawers 20 are positioned at the two ends of the puzzle board (the left and right sides). During folding in half, the drawers approach each other to optimize the space utilization. The semicircular design works in coordination with the arc-shaped track 103 for steady rotation. The removable internal partition and placement trays facilitate the classification of puzzle pieces, without affecting folding. The storage and the cleaning convenience are enhanced. The modules are linked by the folding design of the puzzle board, to complement each other's advantages in different states, thus bringing a user with a convenient and function-enriched puzzle assembling experience and greatly meeting needs for modern diverse scenarios.

For those skilled in the art, it is apparent that the present disclosure is not limited to the details of the exemplary embodiments mentioned above, and can be implemented in other specific forms without departing from the spirit or basic features of the present disclosure. Therefore, in any perspective, the embodiments should be regarded as exemplary and non-restrictive. The scope of the present disclosure is limited by the accompanying claims rather than the above description. Therefore, all changes within the meaning and scope of the equivalent conditions of the claims within the present disclosure.

What is claimed is:

1. A puzzle tool integrated with a multifunctional feature, comprising:
a puzzle board body, wherein the puzzle board body is folded in half along an axis; an insertion slot corresponding to a folding axis of the puzzle board body is provided in a top end of the puzzle board body; a working layer for assisting in doing a puzzle is arranged on a surface;
a bracket assembly, wherein the bracket assembly is inserted into the insertion slot at the top end of the puzzle board body and is detachably connected to the puzzle board body; the bracket assembly comprises a first movable bracket and a second movable bracket that are able to rotate independently or relative to each other; the first movable bracket is configured to support the puzzle board body to cause the puzzle board body to be in an inclined supporting state relative to a placement plane; the second movable bracket is configured to form an object placement position or cooperate with the puzzle board body to form an object placement position; and
a rim, wherein the rim is detachably connected to the puzzle board body; and the rim is correspondingly divided into a first half rim and a second half rim along a central axis of the puzzle board body, to compress the working layer to achieve fixation of the working layer.

2. The puzzle tool integrated with the multifunctional feature according to claim 1, wherein the bracket assembly further comprises a connection member connected to the puzzle board body; the first movable bracket and the second movable bracket are respectively movably connected to the connection member and are able to rotate around connection points;
the connection member is of a plugboard structure; and connection between the bracket assembly and the puzzle board body is achieved by inserting the connection member into the insertion slot.

3. The puzzle tool integrated with the multifunctional feature according to claim 2, wherein a connection shaft is arranged on the connection member;
the first movable bracket is sleeved on the connection shaft and is rotatably connected to the connection shaft;
the second movable bracket is sleeved on the connection shaft, is located between the first movable bracket and the connection member, and is rotatably connected to the connection shaft; and
the first movable bracket and the second movable bracket are able to rotate relative to the connection member around the connection shaft; and the first movable bracket and the second movable bracket are also able to rotate relative to each other around the connection shaft.

4. The puzzle tool integrated with the multifunctional feature according to claim 2, wherein after the connection member is inserted into the insertion slot of the puzzle board body, the first movable bracket and the second movable bracket are fixed to the top end of the puzzle board body; the first movable bracket is able to support the puzzle board body after rotation; and after rotation, the second movable bracket cooperates with the top end of the puzzle board body to form the object placement position.

5. The puzzle tool integrated with the multifunctional feature according to claim 2, wherein the insertion slot corresponds to a folding position of the puzzle board body, so that after the connection member is connected to the puzzle board body, when the puzzle board body is in an unfolded state, the puzzle board body is constrained to suppress a degree of freedom of rotation of the puzzle board body around the folding axis, to maintain stability of unfolding of the puzzle board body.

6. The puzzle tool integrated with the multifunctional feature according to claim 1, wherein a magnetic attraction connection assembly is disposed between the puzzle board body and the rim; and stable magnetic attraction mating between the rim and the puzzle board body is achieved through the magnetic attraction connection assembly.

7. The puzzle tool integrated with the multifunctional feature according to claim 1, wherein a convex platform structure is arranged on a surface of the puzzle board body; an upper surface of the convex platform structure forms a mounting plane of the working layer, and a stepped slot matching with the rim is provided around a periphery of the convex platform structure; and the rim is embedded into the stepped slot.

8. The puzzle tool integrated with the multifunctional feature according to claim 7, wherein the rim has a compression portion and a connection portion that are of an integrated structure;
the compression portion corresponds to the mounting plane of the convex platform structure on the surface of the puzzle board body and is configured to compress the working layer arranged on the mounting plane; and
the connection portion corresponds to a stepped slot around a peripheral side of the convex platform structure and is configured to be embedded into the stepped slot, to achieve stable connection between the rim and the puzzle board body.

9. The puzzle tool integrated with the multifunctional feature according to claim 1, wherein the rim encloses a slot position corresponding to the working layer, and a cover plate that is detachably connected to the puzzle board body is disposed on the slot position; and
when no puzzle assembling operation is performed, the cover plate tightly presses the working layer in the slot position to fix a puzzle on the working layer.

10. The puzzle tool integrated with the multifunctional feature according to claim 1 ,further comprising a drawer rotatably connected to the puzzle board body, wherein the drawer is able to extend out from or be stored into the puzzle board body during rotation.

11. The puzzle tool integrated with the multifunctional feature according to claim 10, wherein the puzzle board body is provided with a built-in slot configured to store the drawer; and the drawer is rotatably connected to the puzzle board body through a rotating shaft, so as to be able to extend out from the built-in slot around the rotating shaft or be stored into the built-in slot.

12. The puzzle tool integrated with the multifunctional feature according to claim 11, wherein the drawer is of a semicircular structure capable of rotating around the rotating shaft serving as a center; and
the built-in slot is in a semicircular shape matching with the drawer.

13. The puzzle tool integrated with the multifunctional feature according to claim 11, wherein an arc-shaped track is arranged on an inner wall of the built-in slot; and an outer contour of the drawer abuts against the arc-shaped track, so that the drawer is able to steadily slide along the arc-shaped track when rotating around the rotating shaft.

14. The puzzle tool integrated with the multifunctional feature according to claim 10, wherein a plurality of partition structures are disposed within the drawer to partition an interior of the drawer into a plurality of independent storage regions through the plurality of partition structures.

15. The puzzle tool integrated with the multifunctional feature according to claim 14, wherein the partition structures are placement trays; shapes of the placement trays match with an inner contour of the drawer; and the placement trays are able to be taken out from the drawer.
